(19) United States
(12) Patent Application Publication
(10) Pub. No.: US 2017/0115552 A1
(43) Pub. Date: Apr. 27, 2017

(54) Image Projection System

(71) Applicant: Jason Ward, Hazel Crest, IL (US)

(72) Inventor: Jason Ward, Hazel Crest, IL (US)

(21) Appl. No.: 14/921,364

(22) Filed: Oct. 23, 2015

(51) Int. Cl. G03B 21/14; G09F 19/18

(52) U.S. Cl. CPC G03B 21/145; G09F 19/18

(57) ABSTRACT

An image projection system includes a vehicle that has box and the box has an outer wall. A projection unit is coupled to the vehicle and the projection unit is positioned on the outer wall. Thus, the projection unit projects an image onto the outer wall thereby facilitating the image to be visible to an observer.

### BACKGROUND OF THE DISCLOSURE

### Field of the Disclosure

The disclosure relates to projection devices and more particularly pertains to a new projection device for projecting an image onto a vehicle.

### SUMMARY OF THE DISCLOSURE

An embodiment of the disclosure meets the needs presented above by generally comprising a vehicle that has box and the box has an outer wall. A projection unit is coupled to the vehicle and the projection unit is positioned on the outer wall. Thus, the projection unit projects an image onto the outer wall thereby facilitating the image to be visible to an observer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of an image projection system according to an embodiment of the disclosure.

FIG. 2 is a right side phantom view of an embodiment of the disclosure.

FIG. 3 is a perspective in-use view of an embodiment of the disclosure.

FIG. 4 is a perspective in-use view of an alternative embodiment of the disclosure.

FIG. 5 is a back view of an embodiment of the disclosure.

FIG. 6 is a schematic view of an embodiment of the disclosure.

### DESCRIPTION OF THE PREFERRED EMBODIMENT

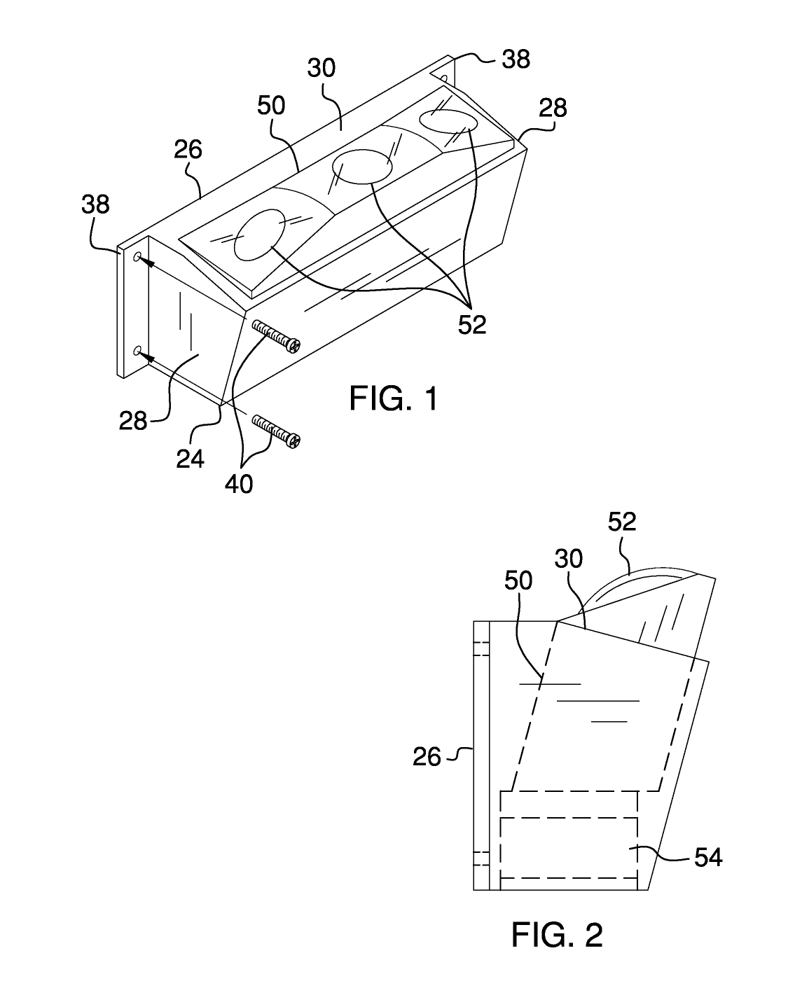

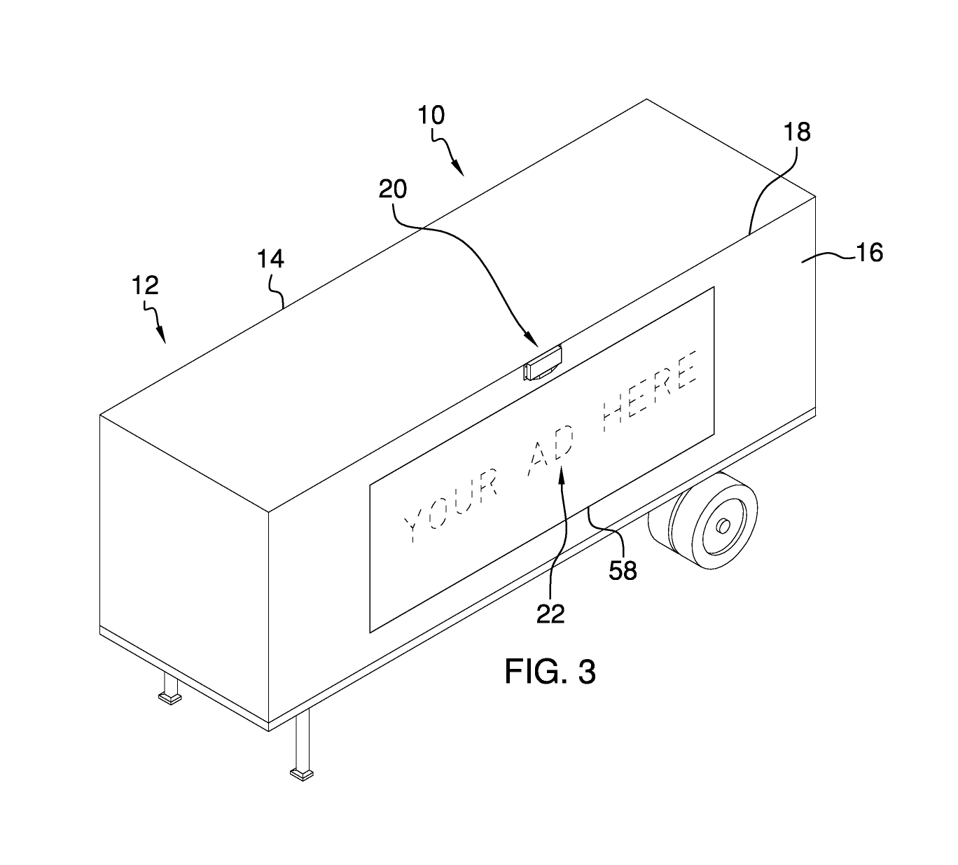

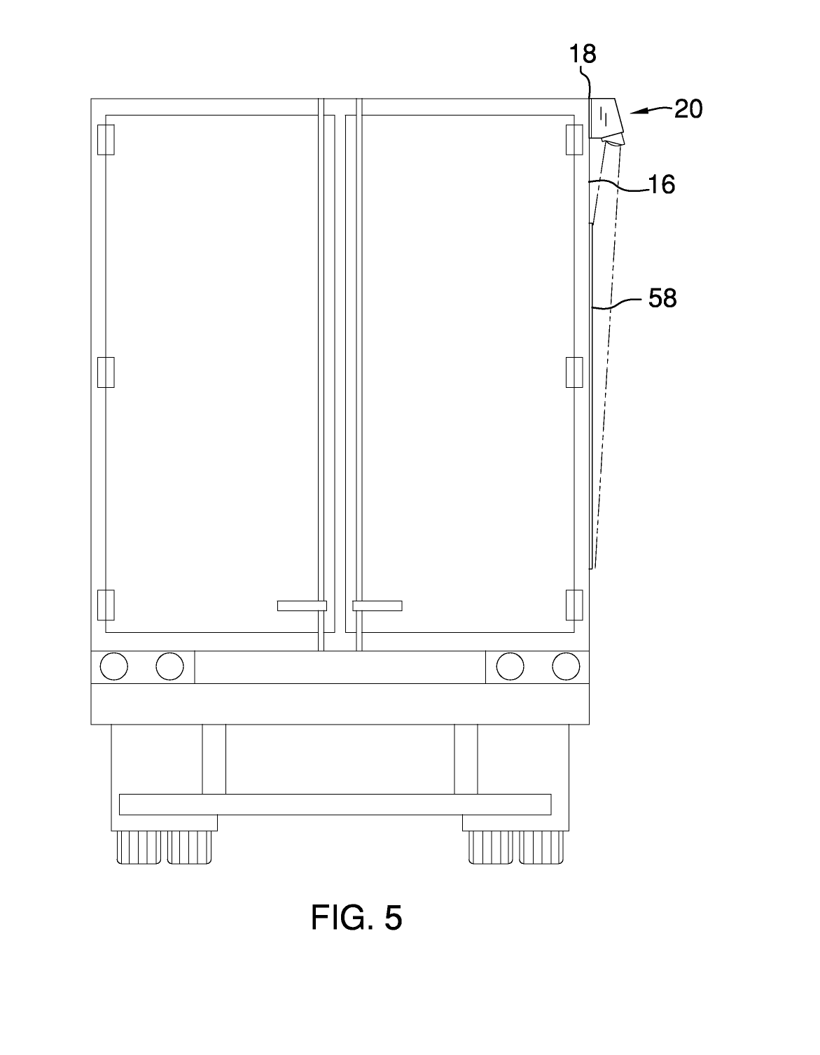

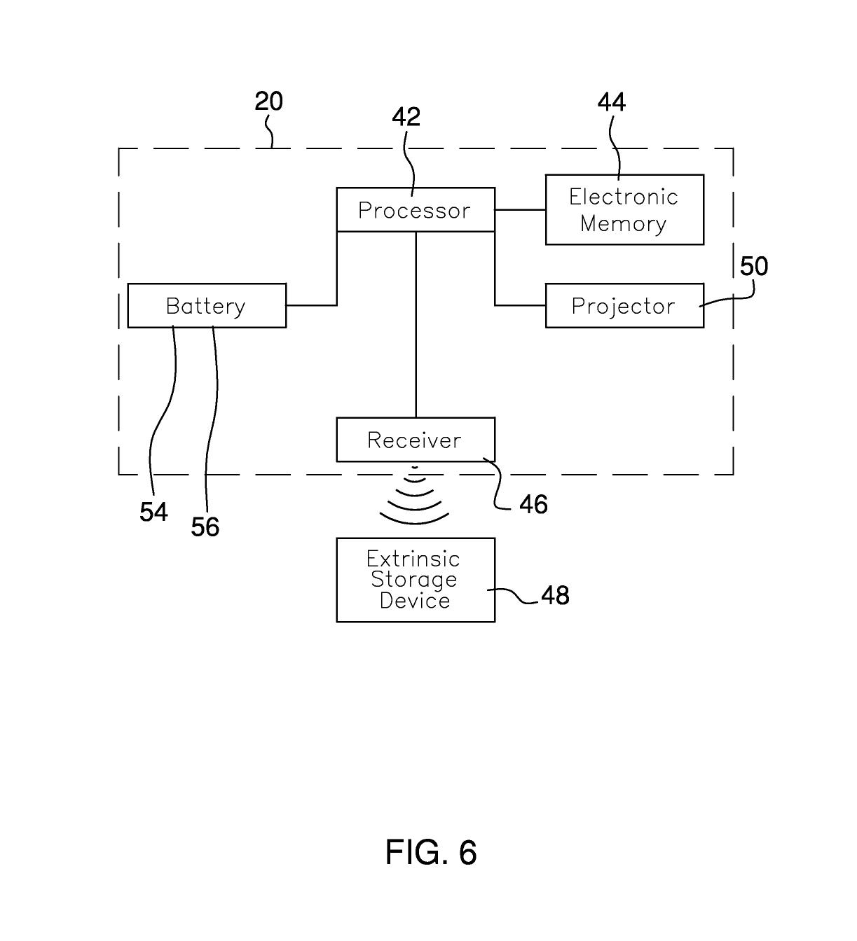

With reference now to the drawings, and in particular to FIGS. 1 through 6 thereof, a new projection device embodying the principles and concepts of an embodiment of the disclosure and generally designated by the reference numeral 10 will be described.

As best illustrated in FIGS. 1 through 6, the image projection system 10 generally comprises a vehicle 12 that has a box 14. The box 14 has an outer wall 16 and a top edge 18. The vehicle 12 may comprise a box truck, a semi truck or other heavy transport vehicle. A projection unit 20 is coupled to the vehicle 12 and the projection unit 20 is positioned on the outer wall 16. Thus, the projection unit 20 projects an image 22 onto the outer wall 16 thereby facilitating the image 22 to be visible to an observer. The image 22 may comprise a billboard advertisement or the like and the observer may be a driver of an extrinsic vehicle.

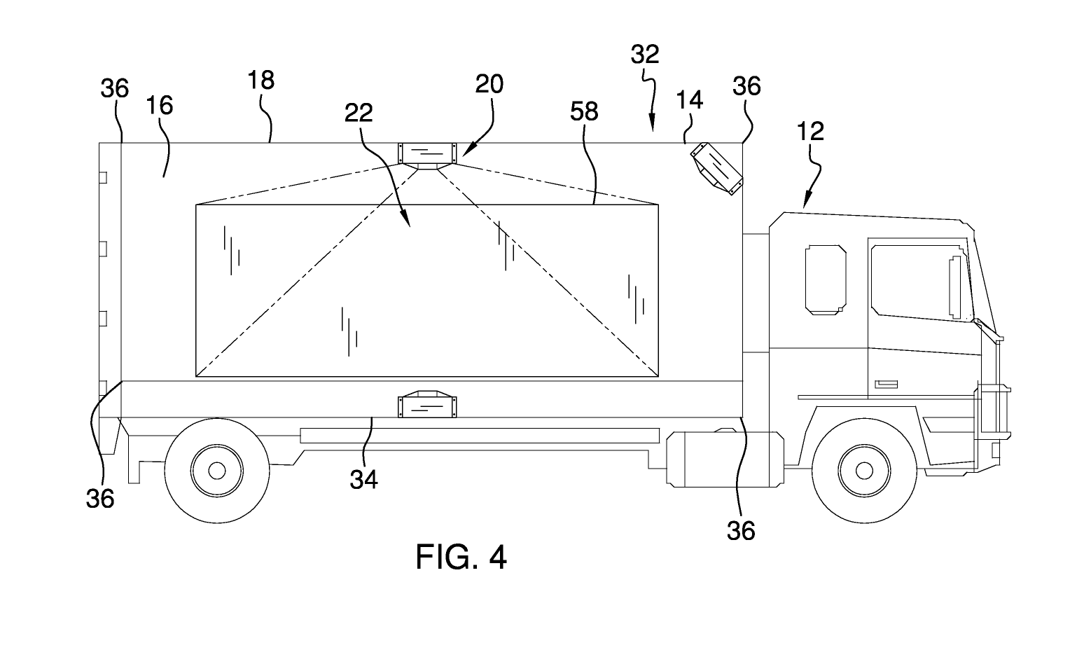

The projection unit 20 comprises a housing 24 that has a back wall 26, a pair of lateral walls 28 and a bottom wall 30. The back wall 26 is coupled to the outer wall 16 of the box 14. The housing 24 may be positioned adjacent to the top edge 18. In an alternative embodiment 32 as shown in FIG. 4, the housing 24 may be positioned adjacent to a bottom edge 34 of the box 14 or adjacent to one of four corners 36 of the box 14. A pair of tabs 38 may each extend outwardly from an associated one of the lateral walls 28. A plurality of bolts 40 may extend through each of the tabs 38 and engage the outer wall 16. Thus, the housing 24 is retained on the box 14.

A processor 42 is positioned within the housing 24. The processor 42 may comprise an electronic processor or the like. The processor 42 includes an electronic memory 44. The electronic memory 44 is electrically coupled to the processor 42. The electronic memory 44 may comprise a hard drive, ROM memory or other electronic memory.

A receiver 46 is positioned within the housing 24 and the receiver 46 is electrically coupled to the processor 42. The receiver 46 may be in electrical communication with an extrinsic storage device 48. The receiver 46 receives data pertaining to the image 22 from the extrinsic storage device 48. The receiver 46 may comprise a radio frequency receiver or the like and the receiver 46 may utilize a WPAN signal or the like. The extrinsic storage device 48 may comprise a personal computer, a smart phone or other electronic storage device with wireless communication capabilities. The electronic memory 44 may store data pertaining to a plurality of images.

A projector 50 is coupled to the bottom wall 30. The projector 50 is electrically coupled to the processor 42 and the projector 50 projects the image 22. The projector 50 may comprise a digital projector or the like. The projector 50 includes an array of lenses 52 and the array of lenses 52 is positioned on the bottom wall 30. Each of the lenses 52 is oriented at a respective angle with respect to the bottom wall 30. Thus, the array of lenses 52 projects the image 22 across a substantial length of the box 14 thereby enhancing visibility of the image 22.

A power supply 54 is positioned within the housing 24. The power supply 54 is electrically coupled to the processor 42. The power supply 54 comprises at least one battery 56. The power supply 54 may be electrically coupled the vehicle 12. A screen 58 is coupled to the outer wall 16 of the box 14. The image 22 is projected onto the screen 58 thereby facilitating the observer to view the image 22.

In use, the image 22 is communicated to the electronic memory 44. The projector 50 projects the image 22 onto the screen 58. The projector 50 may sequentially display a plurality of the images 22 on the screen 58. The image(s) 22 is visible to the observer while the vehicle 12 is being driven. Thus, the vehicle 12 is facilitated to provide advertisement or other means of visual communication.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An image projection system comprising:
a vehicle having box, said box having an outer wall; and
a projection unit being coupled to said vehicle, said projection unit being positioned on said outer wall wherein said projection unit is configured to project an image onto said outer wall thereby facilitating the image to be visible to an observer.

2. The system according to claim 1, wherein said projection unit comprises a housing having a back wall and a bottom wall, said back wall being coupled to said outer wall of said box.

3. The system according to claim 2, further comprising:
a processor being positioned within said housing; and
a receiver being positioned within said housing, said receiver being electrically coupled to said processor, said receiver being configured to be in electrical communication with an extrinsic storage device thereby facilitating said receiver to receive the image from the extrinsic storage device.

4. The system according to claim 3, further comprising a projector being coupled to said bottom wall, said projector being electrically coupled to said processor wherein said projector is configured to project the image.

5. The system according to claim 4, wherein said projector includes a array of lenses, each of said lenses being positioned on said bottom wall, each of said lenses being oriented at a respective angle with respect to said bottom wall wherein said array of lenses is configured to project the image across a substantial length of said box thereby enhancing visibility of the image.

6. The system according to claim 3, further comprising a power supply being positioned within said housing, said power supply being electrically coupled to said processor, said power supply comprising at least one battery.

7. The system according to claim 1, further comprising a screen being coupled to said outer wall wherein said screen is configured to have the image projected thereon thereby facilitating the observer to view the image.

8. An image projection system comprising:
a vehicle having box, said box having an outer wall; and
a projection unit being coupled to said vehicle, said projection unit being positioned on said outer wall wherein said projection unit is configured to project an image onto said outer wall thereby facilitating the image to be visible to an observer, said projection unit comprising:
a housing having a back wall and a bottom wall, said back wall being coupled to said outer wall of said box,
a processor being positioned within said housing,
a receiver being positioned within said housing, said receiver being electrically coupled to said processor, said receiver being configured to be in electrical communication with an extrinsic storage device thereby facilitating said receiver to receive the image from the extrinsic storage device,
a projector being coupled to said bottom wall, said projector being electrically coupled to said processor wherein said projector is configured to project the image, said projector including a array of lenses, each of said lenses being positioned on said bottom wall, each of said lenses being oriented at a respective angle with respect to said bottom wall wherein said array of lenses is configured to project the image across a substantial length of said box thereby enhancing visibility of the image,
a power supply being positioned within said housing, said power supply being electrically coupled to said processor, said power supply comprising at least one battery; and
a screen being coupled to said outer wall wherein said screen is configured to have the image projected thereon thereby facilitating the observer to view the image.
